(19) United States
(12) Patent Application Publication
(10) Pub. No.: US 2016/0043409 A1
(43) Pub. Date: Feb. 11, 2016

(54) Lithium Air Battery

(71) Applicant: SK Innovation Co., Ltd., Seoul (KR)

(72) Inventors: Myoung Gu Park, Daejeon (KR); Ka Young Kim, Daejeon (KR); Jae Hyun Koh, Daejeon (KR); Young Eun Cheon, Daejeon (KR)

(21) Appl. No.: 14/822,128

(22) Filed: Aug. 10, 2015

(30) Foreign Application Priority Data
Aug. 11, 2014 (KR) 10-2014-0103622

(51) Int. Cl. H01M 4/92; H01M 4/38; H01M 4/86; H01M 12/08; H01M 4/88

(52) U.S. Cl. CPC H01M 4/926; H01M 12/08; H01M 4/8875; H01M 4/8668; H01M 4/8882; H01M 4/382

(57) ABSTRACT

Provided is a lithium air battery including an anode occluding and releasing lithium ion; a cathode including a compression-molded body of a catalyst supported carbon body; and a lithium ion conductive electrolyte positioned between the anode and the cathode. More particularly, there is provided a lithium air battery capable of having improved durability, decreasing internal resistance, and having excellent charge and discharge efficiency.

### CROSS-REFERENCE TO RELATED APPLICATION

This application claims priority to Korean Patent Application No. 10-2014-0103622 filed Aug. 11, 2014 the disclosure of which is hereby incorporated in its entirety by reference.

### TECHNICAL FIELD

The following disclosure relates to a lithium air battery, and more particularly, to a lithium air battery capable of having improved durability, decreasing internal resistance, and having excellent charge and discharge efficiency.

### BACKGROUND

Recently, in accordance with an increase in carbon dioxide emission due to consumption of fossil fuel, a rapid change in crude oil price, or the like, development of a technology of converting gasoline and diesel into electric energy as an energy source of a vehicle has been spotlighted. An electric vehicle has been put to practical use, and a lithium ion battery which is a storage battery, should have a large capacity and realize high energy density for long distance driving. However, currently, the lithium ion battery has a limitation in capacity of the battery, and it is difficult to use the lithium ion battery for long-distance driving. Therefore, a lithium air battery theoretically having larger capacity and higher energy density than those of the lithium ion battery has been spotlighted.

The lithium air battery, which is a battery having a cathode using oxygen in the air as an active material, is a battery capable of being charged and discharged by an oxidation-reduction reaction of oxygen in the cathode.

The lithium air battery has a theoretical energy density of 3000 Wh/kg or more, which corresponds to an energy density about times that of the lithium ion battery. In addition, the lithium air battery may be environmentally friendly and provide improved stability as compared to the lithium ion battery.

As disclosed in U.S. Patent Application Publication No. 2013-0011750, as a cathode layer of the lithium air battery is manufactured by preparing cathode slurry containing a catalyst, a porous carbon based material, and a binder, and applying and drying the cathode slurry on a current collector to manufacture a cathode layer, the cathode generally has a multilayer structure of the current collector and the cathode layer. However, in the cathode having this structure, a contact between the carbon based material and the catalyst is not uniform, such that electrical properties may be deteriorated, internal resistance of a cathode active material layer may be large, and durability may be deteriorated due to separation of the current collector and the cathode active material layer.

### RELATED ART DOCUMENT

### Patent Document

U.S. Patent Application Publication No. 2013-0011750

### SUMMARY

An embodiment of the present invention is directed to providing a lithium air battery capable of having improved durability, decreasing internal resistance, stably maintaining an excellent catalytic activity for a long period of time, having excellent charge and discharge efficiency, and being simply and cheaply manufactured.

In one general aspect, a lithium air battery may include an anode occluding and releasing lithium ion; a cathode including a compression-molded body of a catalyst supported carbon body; and a lithium ion conductive electrolyte positioned between the anode and the cathode.

The cathode may be the compression-molded body itself.

The catalyst supported carbon body may contain 5 to 40 wt % of a catalyst.

A catalyst of the catalyst supported carbon body may have an average diameter of 2 to 5 nm.

The compression-molded body may be manufactured by injecting slurry containing a solvent, a binder resin, and the catalyst supported carbon body into a mold, applying a pressure thereto to mold the slurry, and then evaporating to remove the solvent.

The slurry may contain 40 to 50 parts by weight of the binder resin and 40 to 50 parts by weight of the solvent based on 100 parts by weight of the catalyst supported carbon body.

A catalyst may be one or two or more selected from Co, Ni, Fe, Au, Ag, Pt, Ru, Rh, Os, Ir, Pd, Cu, Mn, Ti, V, W, Mo, Nb, and an alloy thereof.

The catalyst supported carbon body may be manufactured by heat treating the catalyst bound onto the carbon body by a polymer as a stabilizer.

The compression-molded body may have an apparent density of 0.2 to 1.0 kg/m³.

The compression-molded body may have specific resistance of 0.9 to 20 Ωm.

### BRIEF DESCRIPTION OF THE DRAWINGS

FIG. 1, which includes portions (a) through (f), shows transmission electronic microscope images of a catalyst supported carbon body manufactured in Manufacturing Example and views illustrating a mapping image of each element;

FIG. 2, which includes portions (a) and (b), shows transmission electronic microscope images of catalyst supported carbon bodies manufactured in Manufacturing Examples;

FIG. 3, which includes portions (a) through (d), shows views illustrating charge and discharge characteristics of lithium air batteries manufactured in Example and Comparative Example;

FIG. 4 is a view illustrating results obtained by measuring discharge capacity depending on the number of charge and discharge cycles of the lithium air batteries manufactured in the Example and the Comparative Example; and

FIG. 5 is a view illustrating result obtained by measuring energy efficiency depending on the number of charge and discharge cycles of the lithium air batteries manufactured in the Example and the Comparative Example.

### DETAILED DESCRIPTION OF EMBODIMENTS

Hereinafter, a lithium air battery according to the present invention will be described in detail with reference to the accompanying drawings. The following accompanying drawings are provided by way of example so that the idea of the present invention can be sufficiently transferred to those skilled in the art to which the present invention pertains. Therefore, the present invention is not limited to the drawings to be provided below, but may be modified in different forms. In addition, the drawings to be provided below may be exaggerated in order to clarify the scope of the present invention. In addition, like reference numerals denote like elements throughout the specification.

Here, technical terms and scientific terms used in the present specification have the general meaning understood by those skilled in the art to which the present invention pertains unless otherwise defined, and a description for the known function and configuration unnecessarily obscuring the gist of the present invention will be omitted in the following description and the accompanying drawings.

The lithium air battery according to an exemplary embodiment of the present invention may include an anode occluding and releasing lithium ion; a cathode including a compression-molded body of a catalyst supported carbon body; and a lithium ion conductive electrolyte positioned between the anode and the cathode.

As described above, as the lithium air battery according to the exemplary embodiment of the present invention has a cathode structure of the compression-molded body formed by compression-molding of the catalyst supported carbon body instead of a multilayer structure of a current collector and a cathode layer, battery internal resistance by the cathode may be significantly decreased, the cathode may have a high density, and durability and safety may be improved.

In the lithium air battery according to the exemplary embodiment of the present invention, the cathode may be the compression-molded body itself of the catalyst supported carbon body. In detail, a separate conductive member may not be provided in the cathode except for the compression-molded body, and the cathode may be composed of only the compression-molded body. That is, the lithium air battery according to the exemplary embodiment of the present invention may not include a current collector (a cathode current collector) according to the related art provided in order to electrically connect the battery with the outside and move or supply (collect) a current consumed in an oxidation reduction reaction generated in the cathode.

In a cathode layer manufactured by applying and drying cathode slurry as in the related art, electrical properties may be deteriorated due to a low density, and mechanical (physical) strength may be significantly weak, such that a current collector enabling a stable and uniform movement and supply (collection) of a current and securing physical strength of the cathode is generally provided. However, in the lithium air battery according to the exemplary embodiment of the present invention, as the cathode includes the compression-molded body of the catalyst supported carbon body, the cathode has a high density due to compression to thereby have low resistance, and excellent mechanical strength due to compression, such that the cathode may be composed of only the molded body.

That is, the cathode according to the exemplary embodiment of the present invention may be made of the compression-molded body of the catalyst supported carbon body, and the molded body may perform all roles of a catalyst, a catalyst supporter (carbon body), and a current collector providing a current movement path alone. In detail, the compression-molded body of the catalyst supported carbon body may provide an open pore structure securing a flow of oxygen gas while integrally providing an electrochemical reaction region in which oxidation and reduction of lithium are generated and movement and supply (collection) region of a charge and discharge current.

In the case in which the cathode is made of the compression-molded body of the catalyst supported carbon body itself according to the exemplary embodiment of the present invention, a separation conductive member may be excluded, such that degradation such as interlayer delamination (separation) generated in a cathode having a multilayer structure (for example, a cathode layer-current collector) may be fundamentally prevented, and safety problems such as gas emission caused by cracks, or the like, of the cathode layer may be solved due to excellent mechanical strength of the molded body. In addition, as the cathode is made of the compression-molded body itself having excellent electric conductivity, battery internal resistance by the cathode may be decreased, and as the cathode has a high density, battery characteristics may be improved.

Further, in the case in which the cathode is made of the compression-molded body of the catalyst supported carbon body, a catalytic activity may be significantly improved, energy efficiency (%) may be excellent, and high energy efficiency may be stably maintained even in the case of repeating charge and discharge cycles.

As described above, in the lithium air battery according to the exemplary embodiment of the present invention, the cathode may include the compression-molded body of the catalyst supported carbon body. In detail, the cathode may be made of the compression-molded body itself of the catalyst supported carbon body. Here, the catalyst supported carbon body may mean a carbon body on which a catalyst is supported. As the catalyst, any catalyst may be used as long as it is generally used for oxidation and reduction of oxygen in the lithium air battery. The catalyst supported carbon body may be in a state in which the carbon body is coated with the catalyst or the catalyst is adsorbed or bound onto a surface (including a surface by open pores, that is, internal portions of the open pores) of the carbon body, and the catalyst may be a particulate catalyst. As the carbon body, any carbon material may be used as long as it is generally used as a matrix which supports a catalyst or on which the catalyst is supported in the lithium air battery.

However, a catalyst supported carbon body that is more effective in the case of configuring the cathode using the compression-molded body according to the exemplary embodiment of the present invention instead of applying slurry on a general current collector will be described.

In the lithium air battery according to the exemplary embodiment of the present invention, the catalyst supported carbon body may contain 5 to 40 wt % of the catalyst. In the lithium air battery according to the exemplary embodiment of the present invention, an average diameter of the catalyst (catalyst particles) of the catalyst supported carbon body may be 2 to 5 nm. The catalyst supported carbon body which has a high catalyst content as described above and on which ultrafine catalyst particles are uniformly and homogeneously dispersed and supported may be prepared by heat treating the catalyst bound onto the carbon body by a polymer as a stabilizer as described below.

As the cathode is composed of the compression-molded body of the catalyst supported carbon body which has a significantly high catalyst content of 5 to 40 wt % and on which the ultrafine catalyst particles homogeneously dispersed and supported, a high density cathode having a significantly increased electrochemical reaction region in which oxidation and reduction of lithium are generated may be implemented, and a cathode having a significantly excellent catalytic activity may be implemented.

As described above, the catalyst supported carbon body may be manufactured by heat heating the catalyst bound onto the carbon body by the stabilizer. As the stabilizer, there are water soluble polymers, (C4-C25) carboxylic acids, organic phosphine compounds, and the like. Since surfaces of a catalyst nanoparticle (or a catalyst cluster) loaded on the carbon body are enclosed by the stabilizer, the stabilizer may serve to maintain a nano size of the catalyst nanoparticle (or the catalyst cluster) and weakly chemically bound onto the surface of the carbon body, such that the catalyst may be impregnated in the carbon body as it is without aggregation. As the stabilizer, the water soluble polymer is preferable. The reason is that the catalyst (particles or clusters) may be bound onto the surface of the carbon body in a state in which the catalyst particles or clusters are uniformly spaced apart from each other due to a spatial interference between long chain structures of the water soluble polymer. That is, as the catalyst particles are spaced apart from each other and bound onto the surface of the carbon body by a polymer stabilizer as described above, at the time of subsequent heat treatment, aggregation of the catalyst may be suppressed, such that a finer particulate catalyst may be supported.

Thereafter, at the time of binding the catalyst to the carbon body by heat treating the catalyst at a temperature at which the stabilizer may be pyrolyzed to thereby be removed, a density of the catalyst particles (or the catalyst clusters) positioned in a diffusion radius in which the catalyst may be supplied with a material may be decreased, such that a significantly fine particulate catalyst may be homogeneously formed on the surface of the carbon body.

In detail, the catalyst bound onto the carbon body by the stabilizer may be prepared by impregnating the carbon body with a solution containing a catalyst precursor and the stabilizer and then, separating, recovering and drying the carbon body.

In more detail, the catalyst supported carbon body may be manufactured by a manufacturing method including: preparing a precursor solution in which the catalyst precursor is dissolved in a solvent and preparing a stabilizer solution in which the stabilizer is dissolved in a solvent; mixing the precursor solution and the stabilizer solution with each other to prepare a mixed solution and refluxing the prepared mixed solution to prepare a dispersion solution (a colloidal solution) of the catalyst cluster enclosed by the stabilizer; injecting a carbon body in the dispersion solution of the catalyst cluster and evaporating to remove the solvent of the dispersion solution to obtain the carbon body to which the catalyst is bound by the stabilizer; and heat treating the obtained carbon body to manufacture the catalyst supported carbon body. In this case, the mixed solution may contain 500 to 900 parts by weight of the stabilizer based on 100 parts by weight of the catalyst precursor, and at the time of injecting the carbon body in the dispersion solution of the catalyst cluster, 150 to 300 parts by weight of the carbon body may be injected based on 100 parts by weight of the catalyst precursor. However, the present invention is not limited thereto.

As the catalyst of the catalyst supported carbon body, any catalyst may be used as long as it is generally used for oxidation and reduction of oxygen in the lithium air battery. A specific example thereof may include one or two or more catalyst metals selected from Co, Ni, Fe, Au, Ag, Pt, Ru, Rh, Os, Ir, Pd, Cu, Mn, Ti, V, W, Mo, Nb, and an alloy thereof. Examples of the catalyst precursor may include chlorides of the above-mentioned catalyst metals, hydrochloric acids thereof, hydrates thereof, or the like.

The stabilizer may be one or two or more materials selected from the water soluble polymers, the (C4-C25) carboxylic acids, the organic phosphine compounds, and the like, wherein the water soluble polymer may include one or more materials selected from polyvinylpyrrolidone, polyvinylalcohol, polyacrylamide, polyacrylic, and copolymers thereof. The (C4-C25) carboxylic acids may include one or more materials selected from oleic acid, stearic acid, lauric acid, palmitic acid, octanoic acid, and decanoic acid. The organic phosphine compound may include trioctylphosphine oxide (TOPO). In this case, when the stabilizer is the water soluble polymer, a weight average molecular weight (Mw) of the used polymer may be 10,000 to 40,000.

As described above, as the carbon body, any conductive carbon material may be used as long as it supports the catalyst or generally used as the matrix on which the catalyst is supported in the lithium air battery. As a specific example, the carbon body may be one or two or more materials selected from carbon black, graphite, graphene, activated carbon, carbon fiber, and carbon nanotube. As a more specific example, the carbon body may be a particulate of one or two or more materials selected from acetylene black, Super P black, carbon black, Denka black, diamond like carbon (DLC), activated carbon, graphite, hard carbon and soft carbon. Although not particularly limited, in the case in which the carbon body on which the catalyst is supported is a particulate, an average particle diameter of the carbon body may be 350 to 550 nm. Further, the carbon body may have a specific surface area of 1 m²/g to 300 m²/g, but is not limited thereto.

The carbon body to which the catalyst is bound by the stabilizer may be heat treated at a temperature of 500 to 900° C. This heat treatment temperature is a temperature at which the stabilizer may be removed and the fine particulate catalyst may be formed on the carbon body. Although not particularly limited, heat treatment may be performed under inert gas atmosphere for 5 to 24 hours.

In the catalyst supported carbon body manufactured by the above-mentioned manufacturing method, one or two or more catalysts selected from Co, Ni, Fe, Au, Ag, Pt, Ru, Rh, Os, Ir, Pd, Cu, Mn, Ti, V, W, Mo, Nb and the alloy thereof may be supported, significantly fine catalyst particles having an average particle diameter of 2 to 5 nm may be uniformly distributed on the carbon body, and the catalyst may be supported at a significantly high content of 5 to 40 wt % (a weight of the catalyst/a weight of the catalyst supported carbon body *100%).

More specifically, in the lithium air battery according to the exemplary embodiment of the present invention, as the catalyst supported carbon body is manufactured by the above-mentioned manufacturing method, the catalyst supported carbon body may be a carbon body in which significantly fine catalyst particles having an average particle diameter of 2 to 5 nm are supported on the carbon body in a crystalline phase and the catalyst particles are physically bound to the carbon body, that is, the catalyst is supported on the carbon body while forming a grain boundary with the carbon body. In addition, the catalyst supported carbon body may have a significantly high catalyst content of 5 to 40 wt %, specifically, 8 to 40 wt %, and more specifically, 10 to 40 wt %, and the catalyst particles may be supported on the carbon body in a state in which the catalyst particles are uniformly dispersed.

In the lithium air battery according to the exemplary embodiment of the present invention, the compression-molded body of the catalyst supported carbon body may be a compression-molded body formed by compression-molding of primary particles of the catalyst supported carbon body. Alternatively, the molded body may be a molded body formed by compression-molding of aggregates in which particles of the catalyst supported carbon body are aggregated. Specifically, in the case in which the catalyst supported carbon body is manufactured by the above-mentioned manufacturing method, the catalyst supported carbon body may be aggregated by heat treatment, and the molded body may be formed by compression-molding of these aggregates of the catalyst supported carbon body as described above.

In a general lithium air battery, a fine porous conductive carbon material is generally used in order to improve a reaction surface area with oxygen. However, as described above, in the lithium air battery according to the exemplary embodiment of the present invention, as the cathode is made of the compression-molded body of the catalyst supported carbon body in which the significantly fine crystalline catalyst particles are uniformly dispersed and supported on the carbon body at a high content, a reaction surface area may be significantly increased by an increase in density by compression-molding. Therefore, it is preferable that a smooth flow (diffusion) of air in the molded body is stably secured by increasing a size of the particles (including the primary particle or a secondary particle, which is the aggregate) of the catalyst supported carbon body. In this regard, in the lithium air battery according to the exemplary embodiment of the present invention, an average size of the particles (including the primary particle or the secondary particle, which is the aggregate) of the compressed catalyst supported carbon body may be 50 to 200 μm, specifically, 100 to 200 μm.

In the lithium air battery according to the exemplary embodiment of the present invention, the compression-molded body may be manufactured by injecting slurry (hereinafter, referred to as ‘molding slurry’) containing a solvent, a binder resin, and the catalyst supported carbon body into a mold and applying a pressure to manufacture a green molded body, and then evaporating to remove the solvent of the green molded body. Here, the green molded body may mean a carbon body on which a catalyst is supported before evaporation of the solvent. As described below, the molding slurry may contain 40 to 50 parts by weight of the solvent based on 100 parts by weight of the catalyst supported carbon body. Since compression-molding is performed in the presence of the solvent, even though the molding slurry is molded at a bulky size, a stable channel (path through which gas may flow) may be formed in the compression-molded body. Therefore, in order to make technical meanings clear, a product obtained by compression-molding the molding slurry, that is, the molded body before the solvent is evaporated to be removed is collectively referred to as the green molded body, and a product obtained by evaporating to remove the solvent from the green molded body is separately referred to as the compression-molded body.

The compression-molded catalyst supported carbon body may be a granulated particle having a size (a diameter of 50 to 200 μm) significantly larger than that of a conductive carbon material used in a general lithium air battery.

The molding may be performed by uni-axial pressing or isostatic pressing, but is not particularly limited thereto. In view of manufacturing a molded body capable of having a high density and excellent strength and allowing air to smoothly flow (diffuse), a molding pressure, which is a pressure applied at the time of molding, may be 3 ton to 5 ton.

As the binder resin, any binder resin may be used as long as it is electrochemically stable at the time of charge and discharge operations of the battery and it is generally used as an organic binding material at the time of manufacturing a cathode layer by applying and drying slurry on a current collector in a general lithium air battery. A specific and non-restrictive example of the binder resin may include one or two or more selected from polyethylene, polypropylene, polytetrafluoro ethylene (PTFE), polyvinylidene fluoride (PVdF), styrene-butadiene rubber, a tetrafluoroethylene-perfluoroalkylvinylether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinylether-tetrafluoro ethylene copolymer, and an ethylene-acrylic acid copolymer. In view of binding the catalyst supported carbon bodies to each other to improve physical strength of the molded body without inhibiting a contact between the catalyst supported carbon bodies, the molding slurry may contain 40 to 50 parts by weight of the binder resin based on 100 parts by weight of the catalyst supported carbon body, but the content of the binder resin is not limited thereto.

As the solvent, any solvent may be used as long as it may dissolve the binder resin and does not chemically react with the catalyst supported carbon body. In detail, the solvent may be a non-aqueous polar organic solvent, where in the non-aqueous polar organic solvent may be one or two or more selected from gamma-butyrolactone, formamide, N,N-dimethylformamide, diformamide, acetonitrile, tetrahydrofuran, dimethylsulfoxide, diethyleneglycol, 1-methyl-2-pyrrolidone, N,N-dimethylacetamide, acetone, α-terpineol, β-terpineol, dihydroterpineol, 2-methoxyethanol, acetylacetone, methanol, ethanol, propanol, butanol, pentanol, hexanol, ketone, and methylisobutyl ketone.

The solvent contained in the molding slurry may serve to dissolve the binder resin and serve as a lubricant allowing the molded body having a homogeneous density to be manufactured. At the same time, the solvent may serve to prevent the catalyst supported carbon body from being excessively compressed by pressure applied at the time of manufacturing the molded body, thereby preventing the molded body from being densely formed. That is, when a molding pressure is applied to a mold after the molding slurry is injected into the mold, the solvent contained in the molding slurry may serve as the lubricant capable of allowing particles (the catalyst supported carbon body) to smoothly move, such that at the time of manufacturing a bulky molded body, a green molded body that is significantly homogeneously compression-molded may be manufactured. Further, at the time of applying the molding pressure to the mold, the solvent, which is a mobile phase, may be significantly homogeneously distributed in the green molded body by the molding pressure, but this solvent, which is the mobile phase, may move and diffuse, but may not be substantially compressed, such that at the time of evaporating to remove the solvent after the molding is completed, the solvent may provide a significantly stable and uniform air flow path in the molded body.

Therefore, when a content of the solvent contained in the molding slurry is excessively high, a density of the molded body may be decreased, and electric conductivity and physical strength of the molded body may be deteriorated. Further, when the content of the solvent contained in the molding slurry is excessively low, density uniformity of the molded body may be deteriorated, and the stable air flow path may not be secured by evaporating to remove the solvent. In this regard, the molding slurry may contain 40 to 50 parts by weight of the solvent based on 100 parts by weight of the catalyst supported carbon body.

The mold into which the molding slurry is injected may have a suitable shape depending on a physical shape or standard of the cathode required in a battery to be designed. For example, the mold may have a tetragonal, circular, or oval cross-sectional shape. Further, as the cathode is manufactured by molding using the mold, a cathode having significantly various concave-convex structures may be manufactured only by forming a concave-convex pattern in an inner surface of the mold. However, the present invention is not limited by a shape of the mold, that is, a shape of the molded body. In this case, a thickness of the molded body may be controlled by adjusting an amount of injected molding slurry.

After the green molded body is manufactured by molding, the solvent contained in the green molded body is evaporated to thereby be removed, thereby obtaining the molded body of the catalyst supported carbon body. In this case, the solvent may be evaporated to thereby be removed at a temperature of 80 to 200° C. and a pressure of 10⁻³ to 10⁻⁷ atm so as to prevent the green molded body from being non-uniformly physically deformed or prevent physical impact from being applied to the green molded body due to evaporation of the solvent.

As described above, in the lithium air battery according to the exemplary embodiment of the present invention, even in the case of manufacturing batteries having various structures and shapes, a cathode satisfying the desired shape and standard may be manufactured only by changing a shape of the mold and adjusting the amount of the molding slurry injected into the mold, and cathodes having various surface concave-convex structures may be manufactured only by forming concave-convex structures in the inner surface of the mold (a surface of the mold coming in contact with the molding slurry). As a specific and non-restrictive example, a cross section of the molded body (a surface of the molded body vertical to a thickness of the molded body) according to the exemplary embodiment of the present invention may have a circular shape, a polygonal shape ranging from triangular to hexagonal shapes, or an oval shape. The molded body may have various thicknesses ranging from a significantly thin thickness to a significantly bulky thickness depending on characteristics and a physical shape of a cathode required in a battery to be designed. Substantially, the molded body may have a thickness of 0.5 mm to 5 mm.

As described above, cathodes having significantly various shapes and standards may be manufactured by a significant simple and cheap process of manufacturing a green molded body and evaporating to remove a solvent, and a current collector having a significantly processed shape such as a porous mesh may be excluded. Therefore, to the exclusion of excellent battery characteristics and battery safety, productivity of the battery may be improved, cost may be decreased, and a design of the battery may be expanded.

In the lithium air battery according to the exemplary embodiment of the present invention, an apparent density of the compression-molded body may be 0.2 to 1.0 kg/m³, preferably 0.7 to 1.0 kg/m³, and specific resistance thereof may be 0.9 to 20 Ωm, preferably 15 to 20 Ωm. As described above, the apparent density and specific resistance of the molded body may be obtained by controlling a size of the catalyst supported carbon body to be compression-molded to form the molded body, the pressure applied at the time of molding, the amount of the binder resin, and/or the amount of the solvent. More specifically, a degree of a physical contact between the catalyst supported carbon bodies, a degree of compression of the catalyst supported carbon body, a size, distribution of the air flow (diffusion) path, or the like, are controlled by the pressure applied at the time of molding, the amount of the binder resin, and the amount of the solvent in addition to the size of the catalyst supported carbon body to be compression-molded to form the molded body, such that the compression-molded body may have an apparent density of 0.2 to 1.0 kg/m³, preferably 0.7 to 1.0 kg/m³, and specific resistance of 0.9 to 20 Ωm, preferably 15 to 20 Ωm. In this case, the specific resistance may mean specific resistance in a thickness direction of the molded body, but the molded body substantially has a homogeneous and uniform fine structure, such that the molded body may have a similar or the same resistance in any direction.

The lithium air battery according to the exemplary embodiment of the present invention may include the anode capable of occluding and releasing lithium; the above-mentioned cathode; and the lithium ion conductive electrolyte positioned between the anode and the cathode.

As the anode, any material may be used as long as it is generally used as an anode occluding and releasing lithium in the lithium air battery. As a specific example, the anode may be a lithium metal or lithium alloy, but is not limited thereto. The lithium alloy may be an alloy of lithium and one or more metals selected from aluminum, tin, magnesium, indium, calcium, germanium, antimony, bismuth, and lead, and a content of lithium in the alloy may be 80 wt % or more.

As the lithium ion conductive electrolyte, any electrolyte may be used as long as it is used as a matrix conducting lithium ion in the lithium air battery. As a specific example thereof, the lithium ion conductive electrolyte may be one or two or more selected from organic electrolytes, aqueous electrolytes, and lithium ion conductive solid electrolytes (hereinafter, referred to as solid electrolytes).

The organic electrolyte may include an aprotic solvent and/or an ionic liquid. As a specific example of the aprotic solvent, there are carbonate based solvents, ester based solvent, ether based solvents, ketone based solvents, amine based solvents, phosphine based solvents, nitrile based solvents, amide based solvents, dioxolane based solvents, or sulfolane based solvents. A specific example of the ionic liquid may include a compound composed of a cation such as imidazolium ion, pyrazolium ion, pyridinium ion, pyrrolidium ion, ammonium ion, phosphonium ion, or sulfonium ion and an anion such as (CF₃SO₂)₂N⁻, (FSO₂)₂N⁻, BF₄⁻, PF₆⁻, AlCl₄⁻, halogen⁻, CH₃CO₄⁻, CF₃CO₂⁻, CH₃SO₄⁻, CF₃SO₃⁻, (CF₃SO₃)N⁻, NO₃⁻, SbF₃⁻, MePhSO₃⁻, (CF₃SO₃)₃C⁻, or (R″)₂PO₂⁻ (R″ is (C1-C5)alkyl). A more specific example of the ionic liquid may include 1-methyl-3-ethyl imidazolium bis(trifluoromethanesulfonyl)imide, 1-methyl-3-propyl imidazoliumbis(trifluoromethanesulfonyl)imide, 1-methyl-3-allyl imidazoliumbis(trifluoromethanesulfonyl)imide, 1-methyl-3-ethyl imidazoliumbis(fluorosulfonyl)imide, 1-methyl-3-propyl imidazoliumbis(fluorosulfonyl)imide, 1-methyl-3-allyl imidazoliumbis(fluorosulfonyl)imide, 1-methyl-1-propyl pyrrolidium bis(trifluoromethanesulfonyl)imide, 1-methyl-1-allyl pyrrolidium bis(trifluoromethanesulfonyl)imide, 1-methyl-1-propyl pyrrolidium (fluorosulfonyl)imide, 1-methyl-1-allyl pyrrolidium (fluorosulfonyl)imide, 1-butyl-3-methylimidazoliumchloride, 1-butyl-3-methylimidazolium dibutylphosphate, 1-butyl-3-methylimidazolium dicyanamide, 1-butyl-3-methylimidazolium hexafluoroantimonate, 1-butyl-3-methylimidazolium hexafluorophosphate, 1-butyl-3-methylimidazolium hydrogen carbonate, 1-butyl-3-methylimidazolium hydrogen sulfate, 1-butyl-3-methylimidazolium methylsulfate, 1-butyl-3-methylimidazolium tetrachloroaluminate, 1-butyl-3-methylimidazolium tetrachloroborate, 1-butyl-3-methylimidazolium thiocyanate, 1-dodecyl-3-methylimidazolium iodide, 1-ethyl-2,3-dimethylimidazolium chloride, 1-ethyl-3-methylimidazolium bromide, 1-ethyl-3-methylimidazolium chloride, 1-ethyl-3-methylimidazolium hexafluorophosphate, 1-ethyl-3-methylimidazolium tetrafluoroborate, 1-hexyl-3-methylimidazolium tetrafluoroborate, 1-butyl-4-methylpyridium chloride, 1-butyl-4-methylpyridium tetrafluoroborate, 1-butyl-4-methylpyridium hexafluorophosphate, benzyldimethyltetradecylammonium chloride, tetraheptylammonium chloride, tetrakis(decyl)ammonium bromide, tributylmethylammonium chloride, tetrahexylammonium iodide, tetrabutylphosphonium chloride, tetrabutylphosphonium tetrafluoroborate, triisobutylmethylphosphonium tosylate, 1-butyl-1-methylpyrrrolidium, 1-butyl-1-methylpyrrolidium bromide, 1-butyl-1-methylpyrrolidium tetrafluoroborate, 1-aryl-3-methylimidazolium bromide, 1-aryl-3-methylimidazolium chloride, 1-benzyl-3-methylimidazolium hexafluorophosphate, 1-benzyl-3-methylimidazolium bis(trifluoromethylsulfonyl)imide, 1-butyl-3-methylimidazolium dibutyl phosphate, 1-(3-cyanopropyl)-3-methylimidazolium bis(trifluoromethylsulfonyl)amide, 1,3-dimethylimidazolium dimethyl phosphate, 1-ethyl-2,3-dimethylimidazolium ethyl sulfate, or the like. Preferably, the example of the ionic liquid may include 1-ethyl-3-methylimidazolium aluminum chloride, 1-butyl-4-methylpyridium hexafluorophosphate, benzyldimethyltetradecylaluminum chloride, tributylmethylaluminum chloride, tetrabutylphosphonium tetrafluoroborate, 1-butyl-1-methylpyrrolidium chloride, 1-butyl-3-methylimidazolium tetrachloroaluminate, 1-butyl-4-methylpyridium chloride, 1-butyl-4-methylpyridium tetrafluoroborate, and the like. This ionic liquid may have advantages such as non-flammability, a low vapor pressure, high thermal stability, and high ion conductivity due to a high ion content.

The organic electrolyte may include alkali metal salts and/or alkali earth metal salts dissolved in the above-mentioned organic solvents. The alkali metal salts and/or alkali earth metal salts may be dissolved in the organic solvent to thereby serve as supply sources of alkali metal and/or alkali earth metal ions in the battery, and serve to promote movement of the lithium ion.

An alkali metal of the alkali metal salt may be one or two or more selected from lithium, sodium, potassium, rubidium, and cesium, and an alkali earth metal of the alkali earth metal salt may be one or two or more selected from beryllium, magnesium, calcium, strontium, and barium.

In the alkali metal salt and/or the alkali earth metal salt, an anion of the salt may be one or two or more selected from PF₆⁻, BF₄⁻, SbF₆⁻, AsF₆⁻, N(SO₂C₂F5)₂⁻, (CF3SO₂)₂N⁻, C₄F₉SO₃⁻, ClO₄⁻, AlO₂⁻, AlCl₄⁻, N(CₓF₂ₓ₊₁SO₂) (C_{y}F_{2y+1}SO₂)⁻ (x and y are each natural numbers), F⁻, Br⁻, Cal⁻, I⁻, and B(C₂O₄)₂⁻.

The aqueous electrolyte may contain aqueous salts of the above-mentioned alkali metal and/or alkali earth metal. A specific example of the aqueous salt based on a lithium salt may include Lion, LiNO₃, Lick, LiCH₃COOH, and the like, but is not limited thereto.

The organic electrolyte or aqueous electrolyte may contain the alkali metal and/or alkali earth metal salt at a concentration of 0.1 to 5M. However, the present invention is not limited by the solvent material, the kind and content of salt of the electrolyte.

Although not particularly limited, the solid electrolyte may include a ceramic based inorganic material such as lithium ion conductive glass or lithium ion conductive crystal; a lithium ion conductive polymer; an inorganic compound; or a mixture thereof.

A specific example of the inorganic compound may include Cu₃N, Li₃N, Lipton, or a mixture thereof, a specific example of the ceramic based inorganic material may include Li_{1+x+y}(Al, Gad)ₓ(Ti, Gee)₂₋ₓSi_{y}P_{3+y}O₁₂(x is a real number satisfying 0≦x≦1 and y is a real number satisfying 0≦y≦1, for example, lithium-aluminum-titanium-phosphate (LATP), lithium-aluminum-titanium-silicon-phosphate (LATSP)), or a mixture thereof, and a specific example of the lithium ion conductive polymer may include a polyethylene oxide doped with a lithium salt.

The lithium air battery according to the exemplary embodiment of the present invention may further include a separator interposed between the anode and the cathode, wherein the separator may be in a form in which a liquid electrolyte (aqueous electrolyte or organic electrolyte) is supported on the separator. As the separator, any material may be used as long as it does not electrochemically react with battery components of the lithium air battery. As an example, the separator may be a non-woven polymer fabric such as a non-woven fabric made of a polypropylene material or polyphenylene sulfide material, or the like; a porous film made of an olefin based resin such as polyethylene, polypropylene, or the like; or a multilayer film thereof.

The lithium air battery according to the exemplary embodiment of the present invention may be divided into an organic lithium air battery provided with the organic electrolyte, an aqueous lithium air battery provided with the aqueous electrolyte, a solid type lithium air battery provided with the solid electrolyte, or complex lithium air battery provided with both of the organic electrolyte and the aqueous electrolyte depending on the kind of electrolyte.

In the organic lithium air battery or aqueous lithium air battery, in order to protect the anode, an anode protection film may be positioned between the anode and the electrolyte, and this anode protection film may be similar to or equal to the solid electrolyte as described above.

The complex lithium air battery may have a structure in which a non-aqueous electrolyte is disposed adjacently to the anode, the aqueous electrolyte is disposed adjacently to the cathode, and these two electrolytes are separated from each other by using the lithium ion conductive solid electrolyte.

The lithium air battery according to the exemplary embodiment of the present invention may be a coin type battery, a button type battery, a sheet type battery, a multilayer type battery, a cylinder type battery, a flat type battery, and a cone type battery.

### MANUFACTURING EXAMPLE

### Manufacturing of Catalyst Supported Carbon Body

A metal precursor solution was prepared by dissolving H₂PtCl₆ (3.75 g) in methanol (118.21 g), and polyvinylpyrrolidone (PVP, M_{w}=40,000, 25.6 g) was dissolved in water (117.8 g), followed by slowly dropping the prepared metal precursor solution thereinto, followed by mixing, thereby preparing a mixed solution in which a metal precursor and PVP, which was a stabilizer, were uniformly mixed with each other. The mixed solution was refluxed for 8 hours or more to thereby be reduced, thereby preparing a Pt nano colloidal solution. After some (90 g) of this solution was extracted and put into Denka black (2.8 g), a solvent was evaporated, thereby impregnating metal nanoparticles contained in the solution into a carbon body. The obtained carbon body containing metal nanoparticles was fired at 500° C. for 5 hours under N2 atmosphere, thereby manufacturing a catalyst supported carbon body.

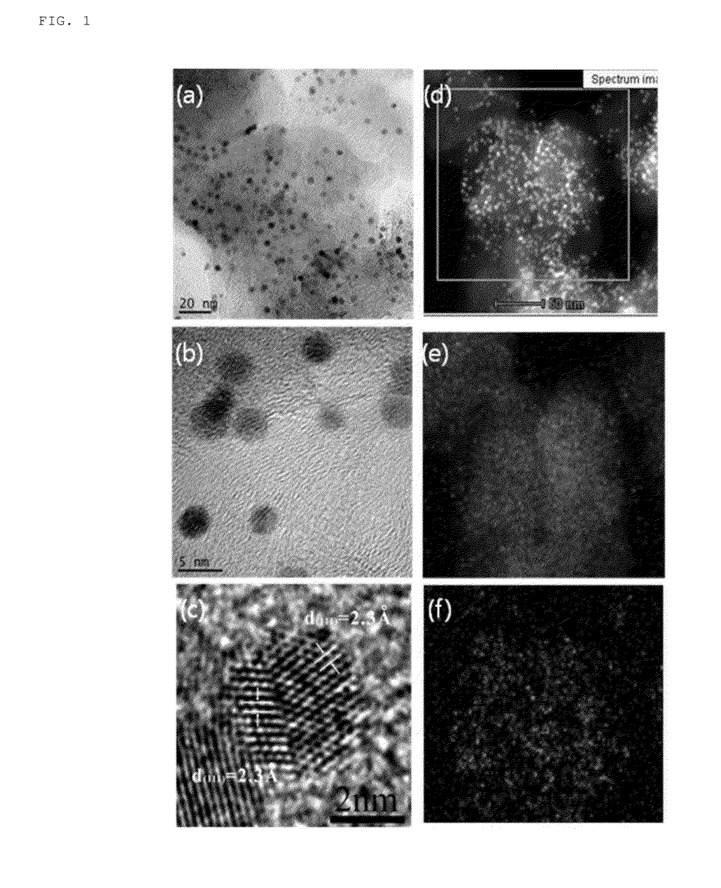

FIGS. 1A and 1B are transmission electron microscope (TEM) images of the catalyst supported carbon body manufactured using Denka black as a carbon body, FIG. 1C is a high resolution (HR)-TEM image obtained by observing the supported catalyst, and FIGS. 1E and 1F are mapping images of C (FIG. 1E) and Pt (FIG. 1F), in a C region indicated by a square in FIG. 1D using energy spectroscopy.

As illustrated in FIGS. 1A to 1F, it may be appreciated that significantly uniform and fine catalyst particles having a diameter of 3.5 to 4.5 nm were supported on the carbon body in a state in which they were uniformly dispersed, and it was confirmed that the catalyst particles had a crystalline phase. Further, it was confirmed through energy spectroscopy and electron diffraction pattern analysis that spherical particulates observed as black dots in the TEM images were Pt crystalline particles. In addition, it was confirmed through observation using a low-resolution scanning electron microscope that a catalyst supported carbon body was manufactured in a form of a secondary particle in which particles were aggregated, and an average diameter of the catalyst supported carbon body was 300 to 500 μm..

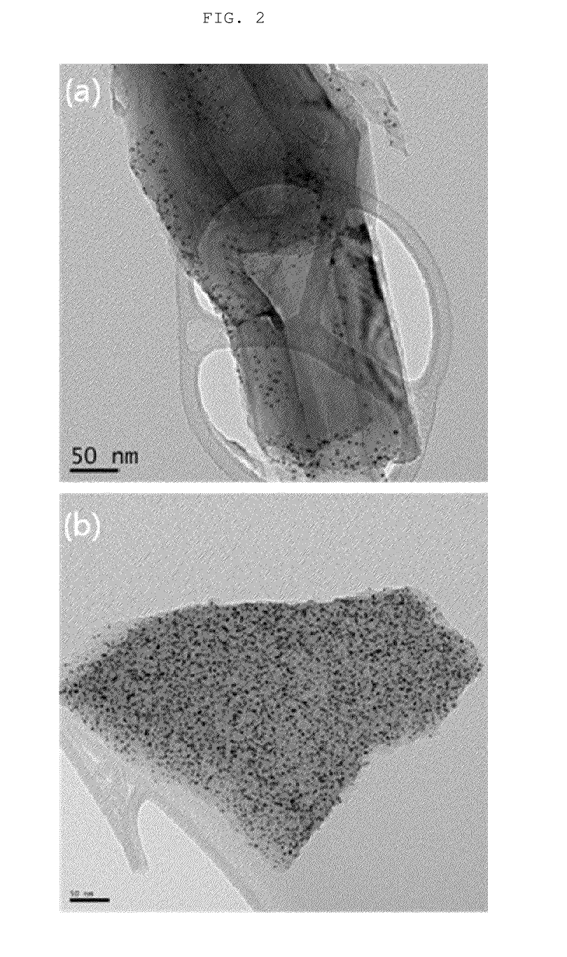

FIG. 2A is a TEM image of a catalyst supported carbon body manufactured by using carbon nanofiber as the carbon body instead of Denka black in Manufacturing Example, and FIG. 2B is a TEM image of a catalyst supported carbon body manufactured by using charcoal as the carbon body instead of Denka black in Manufacturing Example. It was confirmed that catalyst particles having a diameter of 2.5 to 4.5 nm were significantly uniformly and homogeneously dispersed and supported similarly to the case of using Denka black as the carbon body, and crystalline Pt particles were supported.

It was confirmed that a content of Pt supported on the carbon body reached about 10 wt % regardless of the kind of carbon body used in Manufacturing Example.

### EXAMPLE

A cathode was manufactured using the catalyst supported carbon body manufactured using Denka black as the carbon body in the Manufacturing Example.

The catalyst supported carbon body (0.930 g) was put into a binder solution obtained by mixing 1-methyl-2-pyrrolidone (0.437 g) and polyvinylidene fluoride (PVdF, Kureha, KF1700, 0.437 g), followed by mixing, thereby preparing molding slurry.

The molding slurry was injected into a mold made of a steel use stainless (SUS) material, compressed at a pressure of 3 ton for 3 minutes, thereby manufacturing a green molded body having a circular disk shape.

The manufactured green molded body was dried at 10⁻³ atm and 100° C. for 12 hours to remove a solvent in the green molded body, thereby manufacturing a compression-molded body.

The manufactured compression-molded body had a circular disk shape, having a diameter of 10 mm and a thickness of 0.5 mm.

Lithium acetic acid (LiCH₃COOH, molar mass=102.02 g/mol, Sigma-Aldrich, 16.3 g) was dissolved in 1L of D.I. water as a lithium salt, thereby preparing a 1M aqueous electrolyte as a second electrolyte. A lithium metal thin film was used as an anode, and polypropylene (SKI, F305CHP, 525HV) was used as a separator disposed on the lithium metal thin film. The compression-molded body manufactured as described above was used as a cathode (air electrode).

The lithium metal thin film (anode) was installed in a stainless case (a first housing), a separator obtained by injecting an EC:DMC(ethylene carbonate :dimethyl carbonate=1:1 v/v) organic electrolyte (a first electrolyte) in which 1M lithium bis(trifluoromethane sulfonyl)imide (LiTFSi) was dissolved was installed at a portion of the stainless case facing the anode, a solid electrolyte film (OHARA, AG-01) was installed thereon, a receptor into which the prepared aqueous electrolyte was injected was installed thereon, and then, the manufactured compression-molded body (cathode) was set to face the anode. Then, a second housing was pressed thereon to fix a cell, thereby manufacturing a lithium air battery.

### COMPARATIVE EXAMPLE

A coin type battery was manufactured by the same manner in Example except for using a cathode having a general current collector structure instead of using the molded body as the cathode. The cathode having the current collector structure was manufactured by a method of finely cutting carbon fiber and mixing the cut carbon fiber with a polymer binder to form slurry, forming a thin film using the slurry to form carbon paper, and coating catalyst supported carbon body particles manufactured using Denka black as the carbon body in Manufacturing Example on a surface of the carbon paper.

Charge and discharge test was performed using the lithium air batteries manufactured in Example and Comparative Example, and conditions thereof were as follows. Charge and discharge cycles were performed at 25° C., 1 atm, and a constant current mode of 0.25 mA/cm².

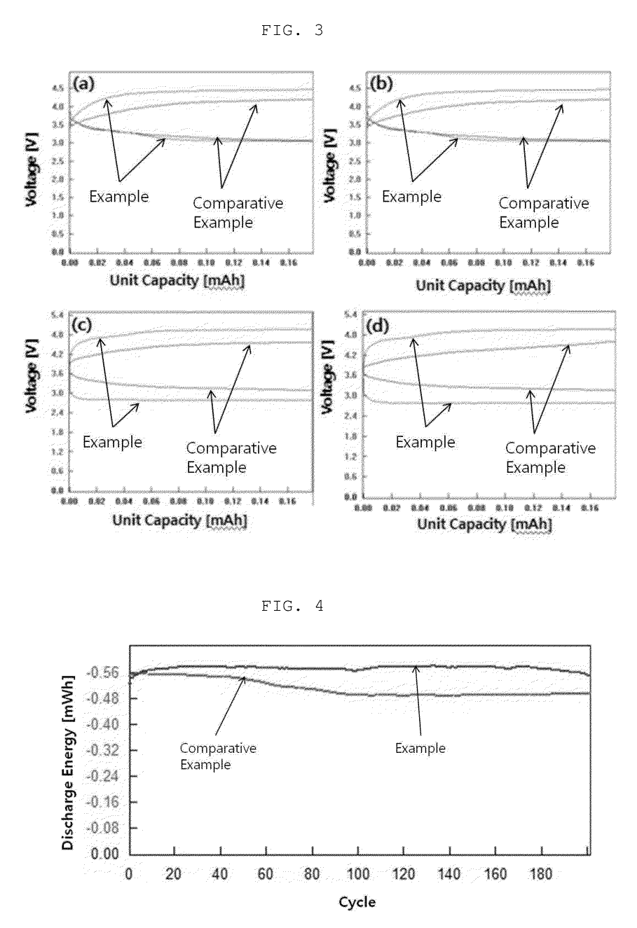

FIGS. 3A to 3D are views illustrating charge and discharge characteristics of the lithium air batteries manufactured in the Example and the Comparative Example, wherein FIGS. 3A, 3B, 3C, and 3D are charge and discharge graphs of the batteries at 10 charge and discharge cycles, 50 charge and discharge cycles, 100 charge and discharge cycles, and 150 charge and discharge cycles, respectively. Referring to FIGS. 3A and 3B, as compared to the case of using a commercialized product (Fuel Cell Earth, EP1019), in the case of using the molded body as the air electrode, a charge voltage was decreased by 12.5% or more. In addition, referring to FIGS. 3C and 3D, as compared to the case of using the commercialized product, in the case of using the molded body, a charge voltage was decreased by 12.5% or more, and a discharge voltage was increased by 12.5% or more, such that the number of charge and discharge cycles was increased, energy efficiency was further improved.

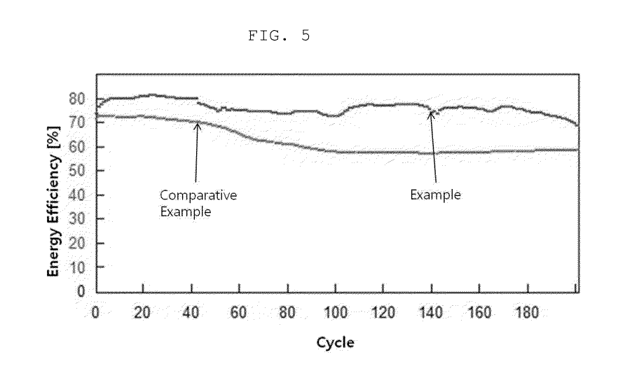

FIGS. 4 and 5 are views illustrating results obtained by measuring discharge capacity and energy efficiency depending on the number of charge and discharge cycles of the lithium air batteries manufactured in the Example and the Comparative Example. As illustrated in FIGS. 4 and 5, it may be appreciated that even though charge and discharge cycles were repeatedly performed, discharge energy and energy efficiency were not substantially deteriorated. Therefore, it may be appreciated that even though charge and discharge cycles were repeatedly performed, a catalytic activity was maintained as it is, and there is almost no degradation in the catalyst.

As described above, as the lithium air battery according to the exemplary embodiment of the present invention has the cathode structure of the compression-molded body formed by compression-molding the catalyst supported carbon body instead of the multilayer structure of the current collector and the cathode layer, battery internal resistance by the cathode may be significantly decreased, the cathode may have a high density, durability and safety may be improved, and the battery may have excellent charge and discharge characteristics.

Hereinabove, although the present invention is described by specific matters, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described embodiments, and the following claims as well as all modified equally or equivalently to the claims are intended to fall within the scope and spirit of the present invention.

What is claimed is:

1. A lithium air battery comprising:
an anode occluding and releasing lithium ion;
a cathode including a compression-molded body of a catalyst supported carbon body; and
a lithium ion conductive electrolyte positioned between the anode and the cathode.

2. The lithium air battery of claim 1, wherein the cathode is the compression-molded body itself.

3. The lithium air battery of claim 1, wherein the catalyst supported carbon body contains 5 to 40 wt % of a catalyst.

4. The lithium air battery of claim 1, wherein a catalyst of the catalyst supported carbon body has an average diameter of 2 to 5nm.

5. The lithium air battery of claim 1, wherein the compression-molded body is manufactured by injecting slurry containing a solvent, a binder resin, and the catalyst supported carbon body into a mold, applying a pressure thereto to mold the slurry, and then evaporating to remove the solvent.

6. The lithium air battery of claim 5, wherein the slurry contains 40 to 50 parts by weight of the binder resin and 40 to 50 parts by weight of the solvent based on 100 parts by weight of the catalyst supported carbon body.

7. The lithium air battery of claim 1, wherein a catalyst is one or two or more selected from Co, Ni, Fe, Au, Ag, Pt, Ru, Rh, Os, Ir, Pd, Cu, Mn, Ti, V, W, Mo, Nb, and an alloy thereof.

8. The lithium air battery of claim 4, wherein the catalyst supported carbon body is manufactured by heat treating the catalyst bound onto the carbon body by a polymer as a stabilizer.

9. The lithium air battery of claim 2, wherein the compression-molded body has an apparent density of 0.2 to 1.0 kg/m³.

10. The lithium air battery of claim 2, wherein the compression-molded body has specific resistance of 0.9 to 20 Ωm.
